(19) United States
(12) Patent Application Publication
(10) Pub. No.: US 2025/0309480 A1
(43) Pub. Date: Oct. 2, 2025

(54) CONNECTING MEMBER, CELL MODULE, AND ENERGY STORAGE BATTERY PACK

(71) Applicant: Jinko Energy Storage Technology Co., Ltd., Haining City (CN)

(72) Inventors: Yuanfu LV, Haining City (CN); Guochao CHEN, Haining City (CN); Yuanhang CHEN, Haining City (CN)

(21) Appl. No.: 18/778,850

(22) Filed: Jul. 19, 2024

(30) Foreign Application Priority Data
Mar. 28, 2024 (CN) 202410371156.4

(51) Int. Cl. H01M 50/503; H01M 50/204; H01M 50/516; H01M 50/522

(52) U.S. Cl. CPC H01M 50/503; H01M 50/516; H01M 50/522; H01M 50/204

(57) ABSTRACT

A connecting member is provided, including a body portion having first and second sides and extending from a first end to a second end of the body portion in a first direction, first and second bending portions, and first and second connecting portions. The first bending portion is bent from the first end towards a second direction on the first side, and the second bending portion is bent from the second end towards the second direction on the second side. The first connecting portion is bent from an end of the first bending portion away from the body portion towards a third direction that is from the second side to the first side. The second connecting portion is bent from an end of the second bending portion away from the body portion towards a fourth direction that is from the first side to the second side.

### CROSS-REFERENCE TO RELATED APPLICATION

The present disclosure claims the benefit of priority under the Paris Convention to Chinese Patent Application 202410371156.4 filed on Mar. 28, 2024, which is incorporated herein by reference in its entirety.

### TECHNICAL FIELD

Embodiments of the present disclosure relate to the field of energy storage, and more particularly to a connecting member, a cell module, and an energy storage battery pack.

### BACKGROUND

In the existing technology, a plurality of cells are usually combined into a whole cell module first, a plurality of cell modules are mounted in series and parallel inside a battery pack, then electrical members and structural fixing members are installed, and finally the battery pack is mounted on a battery rack to form an entire battery cluster, thereby forming the whole energy storage system.

Cell modules are usually assembled in the battery pack, and the cell modules are electrically connected to each other through copper ribbons. A large number of wire harnesses exist in the battery pack, which usually pass through gaps between the cell modules. However, a current energy storage battery cabinet for accommodating the battery pack is compact in space, and in order to allow the cells to occupy a larger space so that the energy storage battery pack has a larger current-carrying capacity as well as a larger degree of integration, gaps between the cell modules may be relatively small, which in turn poses a greater challenge to the space for the installation of the copper ribbons as well as to a current-carrying capability of the copper ribbons. In this way, there may be a risk of temperature rise of the copper ribbons, and most of the electrical connecting members are directly in contact with surfaces of the cell modules, so that the electrical connecting members may be affected when the temperature of the cell modules rises, resulting in a poorer overall stability of the electrical connecting members.

### SUMMARY

Embodiments of the present disclosure provide a connecting member, a cell module, and an energy storage battery pack, which is at least conducive to improving integration of the cell module while ensuring a relatively high current-carrying capability of the connecting member. Some embodiments of the present disclosure provide a connecting member configured to electrically connect output ends of two cell groups, including: a body portion having a first side and a second side opposite to each other, where the body portion extends from a first end of the body portion to a second end of the body portion in a first direction and from a first edge of the body portion to a second edge of the body portion in a second direction; a first bending portion and a second bending portion, where the first bending portion and the second bending portion are respectively disposed at the first end and the second end of the body portion, the first bending portion is connected to the first end of the body portion and is bent from the first end of the body portion towards the second direction on the first side of the body portion, and the second bending portion is connected to the second end of the body portion and is bent from the second end of the body portion towards the second direction on the second side of the body portion; a first connecting portion, where the first connecting portion is connected to an end of the first bending portion away from the body portion and is bent from the end of the first bending portion towards a third direction, and the third direction is a direction from the second side to the first side; and a second connecting portion, where the second connecting portion is connected to an end of the second bending portion away from the body portion and is bent from the end of the second bending portion towards a fourth direction, and the fourth direction is a direction from the first side to the second side.

In some embodiments, the first bending portion and the first side has a first included angle, the second bending portion and the second side has a second included angle, and at least one of the first included angle and the second included angle is in a range of 0° to 30°.

In some embodiments, the first bending portion has a first bending angle, the second bending portion has a second bending angle, and at least one of the first bending angle and the second bending angle is greater than 0° and less than 90°.

In some embodiments, the first bending portion and the first side have a first distance L1 in the third direction, the first bending portion and the second bending portion have a second distance L2 in the third direction, and a ratio of the first distance L1 to the second distance L2 is in a range of 1% to 50%.

In some embodiments, the first distance L1 is in a range of 0 mm to 2.5 mm.

In some embodiments, the body portion includes a first buffer structure, and the first buffer structure is disposed between the first bending portion and the second bending portion.

In some embodiments, the first direction and the third direction form a reference surface, and an orthographic projection of the first buffer structure on the reference surface has a wave shape or a folding line shape.

In some embodiments, the connecting member further includes a second buffer structure, where the second buffer structure is disposed on at least one of the first bending portion and the second bending portion.

In some embodiments, the first connecting portion and the body portion has a third distance, the second connecting portion and the body portion has a fourth distance, and at least one of the third distance and the fourth distance is in a range of 2 mm to 100 mm.

Some embodiments of the present disclosure provide a cell module, including: at least two cell groups, where each of the at least two cell groups includes an output end, and the output end includes an output connector; and the connecting member according to any one of the above embodiments, where both ends of the connecting member are in electrical contact with output connectors of two of the at least two cell groups, respectively.

In some embodiments, the cell module further includes an endplate, where the endplate is disposed at both ends of the at least two cell groups, and the first connecting portion of the connecting portion is disposed on the endplate; and an output base disposed on the endplate; where the body portion of the connecting portion has a top surface that is not higher than a bottom surface of the output base.

In some embodiments, the cell module further includes connecting structures, where the connecting structures are disposed between the first connecting portion of the connecting member and the output connector and between the second connecting portion of the connecting member and the output connector, respectively.

In some embodiments, the connecting structure surrounds one of the first connecting portion and the second connecting portion.

In some embodiments, each of the at least two cell groups includes at least one column of cells arranged in the third direction.

In some embodiments, each of the at least two cell groups includes two columns of cells arranged in the third direction.

Some embodiments of the present disclosure provide an energy storage battery pack, including a plurality of cell modules according to any one of the above embodiments.

### BRIEF DESCRIPTION OF THE DRAWINGS

One or more embodiments are described by way of example with reference to the corresponding figures in the accompanying drawings, and the descriptions are not to be construed as limiting the embodiments. Unless otherwise particularly stated, the figures in the accompanying drawings are not drawn to scale. To describe the technical solutions in the embodiments of the present disclosure or the conventional technology more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a connecting member according to an embodiment of the present disclosure.

FIG. 2 is another schematic structural diagram of a connecting member according to an embodiment of the present disclosure.

FIG. 3 is a top view of a connecting member according to an embodiment of the present disclosure.

FIG. 4 is a left view of a connecting member according to an embodiment of the present disclosure.

FIG. 5 is another left view of a connecting member according to an embodiment of the present disclosure.

FIG. 6 is a partial cross-sectional view of a connecting member according to an embodiment of the present disclosure.

FIG. 7 is a partial schematic structural diagram of a cell module according to an embodiment of the present disclosure.

FIG. 8 is another partial schematic structural diagram of a cell module according to an embodiment of the present disclosure.

### DETAILED DESCRIPTION OF THE EMBODIMENTS

It is seen from the Background that a conventional cell module has a limited degree of integration, and a conventional connecting member has a poor current-carrying capability.

Embodiments of the present disclosure provides a connecting member including a body portion, a first bending portion, a second bending portion, a first connecting portion and a second connecting portion. The body portion extends from a first end of the body portion to a second end of the body portion in a first direction and from a first edge of the body portion to a second edge of the body portion in a second direction. The first bending portion and the second bending portion are disposed at the first and second ends of the body portion, the first bending portion connected to the first end of the body portion and is bent from the first end of the body portion towards the second direction on the first side of the body portion, and the second bending portion connected to the second end of the body portion and is bent from the second end of the body portion towards the second direction on the second side of the body portion The first connecting portion is bent from an end of the first bending portion away from the body portion towards a third direction, and the third direction is a direction from the second side to the first side. The second connecting portion is bent from an end of the second bending portion away from the body portion towards a fourth direction, and the fourth direction is a direction from the first side to the second side. This makes a length of the connecting member no longer limited to a gap between cell modules, i.e., a length direction of the connecting member is changed from an arrangement direction of two cell modules to a vertical direction and a horizontal direction, so that a width direction of the body portion can be a vertical direction of the cell module. In this way, at least the length in the length direction of the connecting member can be increased to a length of one cell module and a height of one cell module. Compared to the conventional solution that the connecting member electrically connects adjacent cell modules in the horizontal direction, the length of the connecting member in the present disclosure can be increased so as to ensure that the connecting member has a sufficient length for ensuring current-carrying between total output ends of different cell modules, and thus avoiding thermal problems and loss of current-carrying of the cell module caused by excessive current-carrying.

In addition, the first bending portion is bent from the first end towards the second direction on the first side, and the second bending portion is bent from the second end towards the second direction on the second side. A gap between two cell modules does not need to occupy a large space because of current-carrying and installation problems of the connecting member, so that the gap between the two cell modules can be shortened, and a part of the space can be reduced in the length direction of the cell module to be given to other components, so as to improve the integration of cell modules. A bending surface of the first bending portion and a bending surface of the second bending portion are opposite to each other, so that either of the first bending portion and the second bending portion can counteract fluctuations from the other, without greatly affecting the deformation of the first bending portion or the second bending portion itself.

The following describes embodiments of the present disclosure in detail with reference to the accompanying drawings. However, a person of ordinary skill in the art may understand that, in the embodiments of the present disclosure, in order to make the reader better understand the present disclosure, many technical details are provided. However, even without these technical details and various changes and modifications based on the following embodiments, the technical solutions claimed in the present disclosure may also be implemented.

In the description of the embodiments of the present disclosure, the technical terms “first” “second” and the like are only used to distinguish different objects and cannot be understood as indicating or implying relative importance or implicitly indicating the number, specific order, or primary and secondary relationship of the indicated technical features. In the description of the embodiments of the present disclosure, “a plurality of” means at least two, unless otherwise specified.

Reference herein to “embodiment” means that a particular feature, structure, or characteristic described in connection with the embodiment may be included in at least one embodiment of the present disclosure. The appearances of this phrase in various places in the specification are not necessarily all referring to the same embodiment, nor are separate or alternative embodiments that are mutually exclusive with other embodiments. It is explicitly and implicitly understood by those skilled in the art that the embodiments described herein may be combined with other embodiments.

In the description of the embodiments of the present disclosure, the term “and/or” is merely an association relationship describing associated objects, indicating that there may be three relationships, for example, A and/or B, which may indicate that A exists, A and B exist at the same time, and B exists. In addition, the character “/” in this specification generally indicates an “or” relationship between the associated objects.

In the description of the embodiments of the present disclosure, the term “a plurality of” means at least two, similarly, “a plurality of groups” means at least two groups, and “a plurality of pieces” means at least two pieces.

In the description of the embodiments of the present disclosure, orientation or positional relationship indicated by technical terms “center”, “transverse”, “longitudinal”, “length”, “width”, “thickness”, “up”, “down”, “front”, “rear”, “left”, “right”, “vertical”, “horizontal”, “top”, “bottom”, “inside” “outside”, “clockwise”, “counterclockwise”, “axial”, “radial”, “circumferential” and the like are orientations or positional relationships based on those shown in the accompanying drawings, which are intended only to facilitate the description of embodiments of the present disclosure and to simplify the description, and are not intended to indicate or imply that the device or element referred to must have a particular orientation, be constructed and operated with a particular orientation, and therefore are not to be construed as a limitation of the embodiments of the present disclosure.

In the description of the embodiments of the present disclosure, unless otherwise specified and limited, technical terms “mounted”, “connected”, “connecting”, “fixed”, etc. are to be understood in a broad sense. For example, it may be a fixed connection, a removable connection, or a one-piece connection, it may be a mechanical connection, or an electrical connection, it may be a direct connection, or an indirect connection through an intermediate medium, and it may be a connection between two elements or an interaction between the two elements. For those of ordinary skill in the art, specific meanings of the above terms in the embodiments of the present disclosure may be understood according to specific situations.

In the accompanying drawings corresponding to the embodiments of the present disclosure, for better understanding and ease of description, the thickness and area of a layer are enlarged. When a component (e.g., a layer, a film, a region, or a substrate) is described as being formed over another component or over a surface of another component, the component may be “directly” on the surface of another component, or a third component may exist between the two components. In contrast, when a component is described as being formed on a surface of another component or a surface of a component is formed or provided with another component, there is no third component between the two components. In addition, when a component is described as being “substantially” formed on/over another component, it means that the component is not formed on/over the entire surface (or front surface) of another component, nor on/over a portion of the edge of the entire surface.

In the description of the embodiments of the present disclosure, when a component “includes” another component, unless otherwise stated, other components are not excluded, and other components may be further included in the component. In addition, when a component such as a layer, a film, a region, or a plate is referred to as being “over/disposed over” another component, it may be “directly on” another component (i.e., being on the surface of another component and there is no other component therebetween), or another component may exist therebetween. Furthermore, when a component such as a layer, film, region, plate, etc. is “directly on” another component, or when a component such as a layer, film, region, plate, etc. is disposed on the surface of another component, it means that no other component is disposed therebetween.

The terminology used in the description of the various described embodiments herein is for the purpose of describing particular embodiments only and is not intended to be limiting. As used in the description of the various embodiments described and the appended claims, “the portion” is also intended to include the plural forms as well, unless the context clearly indicates otherwise. The component includes a layer, a film, a region, or a plate, etc.

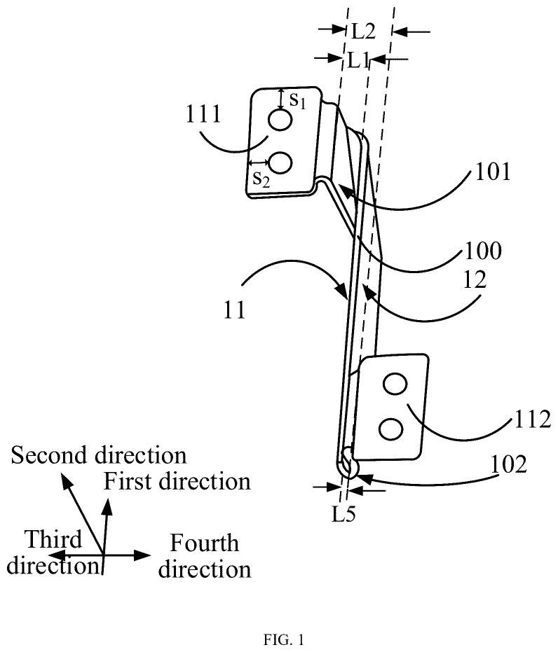

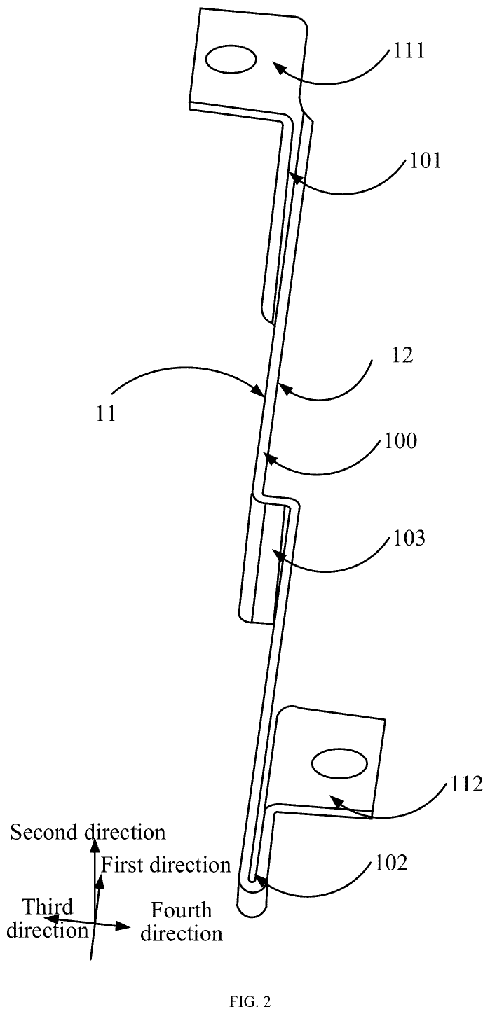

FIG. 1 is a schematic structural diagram of a connecting member according to an embodiment of the present disclosure, and FIG. 2 is another schematic structural diagram of a connecting member according to an embodiment of the present disclosure.

Referring to FIG. 1, according to some embodiments of the present disclosure, an aspect of the embodiments of the present disclosure provides a connecting member, configured to electrically connect output ends of two cell groups, including: a body portion 100 (referring to FIG. 3) having a first side 11 and a second side 12 opposite to each other, a first bending portion 101, a second bending portion 102, a first connecting portion 111, and a second connecting portion 112. The body portion 100 extends from a first end of the body portion 100 to a second end of the body portion 100 in a first direction and from a first edge of the body portion 100 to a second edge of the body portion 100 in a second direction. The first bending portion 101 and the second bending portion 102 are disposed at the first end and the second end of the body portion 100, the first bending portion 101 is connected to the first end of the body portion 100 and is bent from the first end of the body portion 100 towards the second direction on the first side 11 of the body portion 100, and the second bending portion 102 is connected to the second end of the body portion 100 and is bent from the second end of the body portion 100 towards the second direction on the second side 12 of the body portion 100. The first connecting portion 111 is connected to an end of the first bending portion 101 away from the body portion 100, the first connecting portion 111 is bent from the end of the first bending portion 101 towards a third direction, and the third direction is a direction from the second side 12 to the first side 11. The second connecting portion 112 is connected to an end of the second bending portion 102 away from the body portion 100, the second connecting portion 112 is bent from the end of the second bending portion 102 towards a fourth direction, and the fourth direction is a direction from the first side 11 to the second side 12.

In some embodiments, the connecting member is generally used to electrically connect total output ends of two cell modules, and the connecting member is configured to connect two adjacent cell modules in series or in parallel.

In some embodiments, one end of the connecting member is electrically connected to a total output end of one cell module, the other end of the connecting member is electrically connected to an external device, and the external device may include a shunt, a control end or a total output end of an energy storage battery pack, etc.

In some embodiments, the connecting member may be a copper ribbon, the copper ribbon has characteristics of metal copper. First, the copper has a low resistance, so that the loss in the process of transmitting the current is relatively small. Second, the copper is cheap, so that the preparation cost of the whole battery pack is low. Third, the copper has a large current-carrying capacity, so that it can ensure that the current of a cell module is transmitted by the copper ribbon without having a big safety hazard. Fourth, the copper ribbon has good heat dissipation capacity and thermal conductivity, so that it can avoid the thermal problem of the connecting member itself and can also improve the stability and safety of the cell module including the connecting member.

In some embodiments, the total output end is configured to be electrically connected to another cell module or device and is configured to implement electric energy output or input. The total output end includes a total positive output end or a total negative output end. The connecting member may be electrically connected to the total positive output end. The connecting member may also be electrically connected to the total negative output end.

In some embodiments, a length of the connecting member is not limited to a gap between two cell modules through the first bending portion 101, the second bending portion 102, and mutual cooperation of the first bending portion 101 and the second bending portion 102, that is, a length direction of the connecting member is changed from the arrangement direction of the two cell modules to the vertical direction and the horizontal direction, so that a width direction of the body portion can be the vertical direction of the cell module. In this way, at least the length in the length direction of the connecting member can be increased to a length of one cell module and a height of one cell module. Compared to the conventional solution that the connecting member electrically connects adjacent cell modules in the horizontal direction, the length of the connecting member in the present disclosure can be increased so as to ensure that the connecting member has a sufficient length for ensuring current-carrying between total output ends of different cell modules, and thus avoiding thermal problems and a current-carrying loss of the cell module caused by excessive current carrying.

In addition, since the structure and the special bending direction of the connecting member are changed, the gap between the two cell modules does not need to occupy a large space because of current-carrying and installation problems of the connecting member, so that the gap between the two cell modules can be shortened, and a part of the space can be reduced in the length direction of the cell module to be given to other components, so as to improve the integration of the cell modules.

In some embodiments, the length direction of the connecting member is changed from the arrangement direction of the two cell modules to the vertical direction and the horizontal direction, so that the area of the first side 11 and the area of the second side 12 do not need to be reduced for a low-voltage connector and avoiding interference between the connecting member and the low-voltage connector, and cross sections of the first side 11 and the second side 12 or a cross section of the body portion 100 extend in a height direction of a cell, so that a cross-sectional area of the connecting member is increased, and a resistance of the connecting member is reduced.

In some embodiments, the first bending portion 101 is bent along the third direction from the first side 11 towards the second direction (i.e., the first bending portion 101 is bent from the first end of the body portion 100 towards the second direction on the first side 11 of the body portion 100), and the second bending portion 102 is bent along the fourth direction from the second side 12 towards the second direction (i.e., the second bending portion 102 is bent from the second end of the body portion 100 towards the second direction on the second side 12 of the body portion 100). A bending surface of the first bending portion 101 and a bending surface of the second bending portion 102 are opposite to each other, because the fourth direction and the third direction are opposite to each other, so that any one of the first bending portion 101 and the second bending portion 102 can counteract the fluctuation caused by the other, without greatly affecting the deformation of the first bending portion 101 or the second bending portion 102 itself.

In addition, the design of the first bending portion 101 and the second bending portion 102 may also avoid direct contact between the body portion 100 and the cell module, and the space between the body portion 100 and the cell module is at least a thickness of one connecting member, so that a contact area between the body portion 100 and the cell module and a contact area between the connecting member and the cell module can be reduced, thereby helping to avoid interference and thermal problems between the connecting member and each component of the cell module. The bending design of the first bending portion 101 and the second bending portion 102 enables a gap between the body portion 100 and the cell module, which facilitates the heat dissipation of the connecting member itself and avoids the shaking of the cell module when the connecting member shakes, thereby improving the stability of the cell module.

In some embodiments, the first connecting portion 111 is bent from the end of the first bending portion 101 away from the body portion 100 towards the third direction, and the third direction is a direction from the second side 12 to the first side 11. The second connecting portion 112 is bent from the end of the second bending portion 102 away from the body portion 100 towards the fourth direction, and the fourth direction is a direction from the first side 11 to the second side 12. It can be seen that the bending directions of the first connecting portion 111 and the second connecting portion 112 are opposite to each other, in this way, directions of forces applied on the first connecting portion 111 and the second connecting portion 112 are opposite to each other and directions of deformation of the first connecting portion 111 and the second connecting portion 112 are opposite to each other, which may improve structural strength of the connecting member, and the connecting member may also deform in two different directions, thereby avoiding interference between the first connecting portion 111 and the second connecting portion 112.

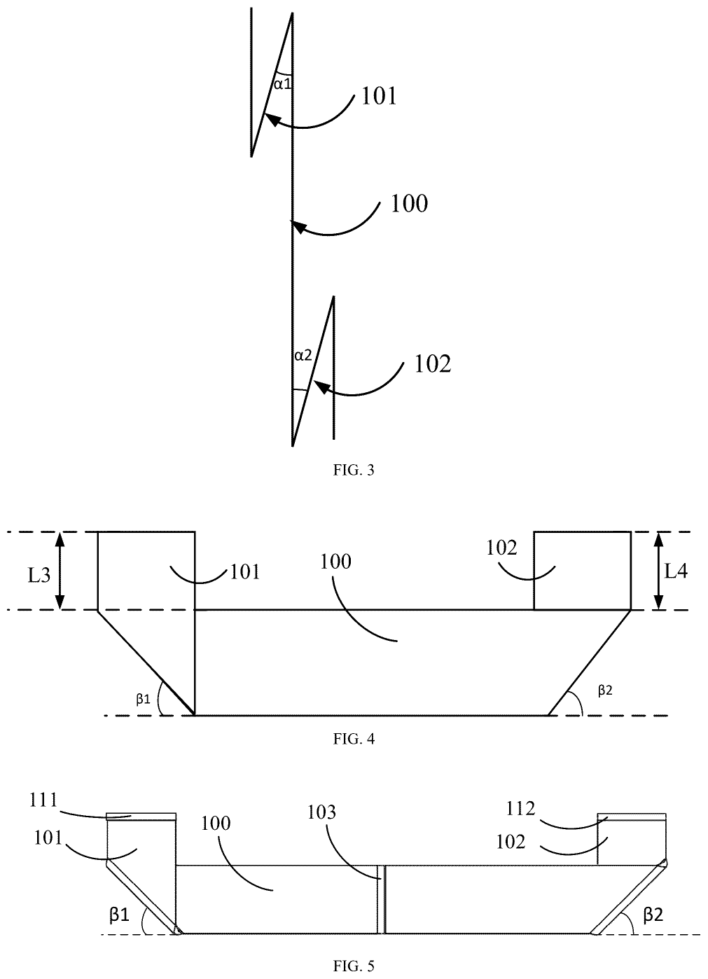

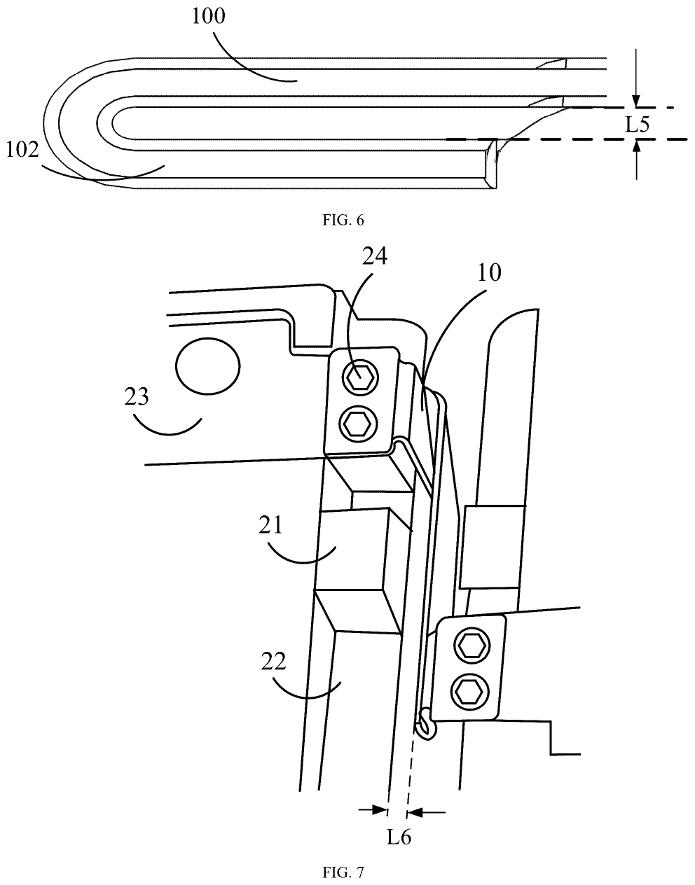

FIG. 3 is a top view of a connecting member according to an embodiment of the present disclosure. FIG. 4 is a left view of a connecting member according to an embodiment of the present disclosure. FIG. 5 is another left view of a connecting member according to an embodiment of the present disclosure. FIG. 6 is another partial cross-sectional view of a connecting member according to an embodiment of the present disclosure.

In some embodiments, referring to FIG. 3, the first bending portion 101 and the first side 11 have a first included angle α₁, the second bending portion 102 and the second side 12 have a second included angle α₂, and at least one of the first included angle and the second included angle is in a range of 0° to 30°, which may be, for example, 0°, 8°, 13°, 16°, 22°, 26°, 30°, etc. With either of the first included angle and the second included angle being in the above range, the deformation degree of the first bending portion 101 can satisfy and offset an installation tolerance between the two cell modules, and the deformation of the first bending portion 101 does not exceed a deformation degree of the connecting member itself, so that the connecting member itself has a large strength and a structural strength. Moreover, the deformation degree of the first bending portion 101 also needs to ensure that there is no interference between edges of the first bending portion 101 and second bending portion 102 and the cell module. Similarly, the deformation degree of the second bending portion 102 also has the same technical effect as that of the first bending portion 101.

In some embodiments, referring to FIG. 4 or FIG. 5, the first bending portion 101 has a first bending angle β₁, the second bending portion 102 has a second bending angle β₂, and at least one of the first bending angle β₁ and the second bending angle β₂ is in a range of 0° to 90°, which may be, for example, 0°, 20°, 30°, 45°, 53°, 66°, 90°, etc. With either of the first bending angle β₁ and the second bending angle β₂ being in the above range, a length of the first bending portion 101 in the first direction is not relatively long, so that the body portion 100 has a larger space, thereby improving the length of the connecting member. Similarly, the deformation degree of the second bending portion 102 also has the same technical effect as that of the first bending portion 101, which is not repeated herein.

In some embodiments, an extension direction of the length of the body portion 100 may not be perpendicular to the second direction, i.e., the first direction may intersect with the second direction, and an intersection angle is in a range of 0° to 90°. When the extension direction of the length of the body portion 100 is perpendicular to the second direction, the connecting member may have a large length to transmit a current through the cooperation of the first bending portion 101 and the second bending portion 102.

In some embodiments, a width of the body portion 100 may be the same as a width of the first bending portion 101 and a width of the second bending portion 102, and the width of the body portion 100 may also be greater than the width of the first bending portion 101 and the width of the second bending portion 102. A relationship of the width of the body portion 100 and the width of the first bending portion 101 as well as a relationship of the width of the body portion 100 and the width of the second bending portion 102 is not limited in the present disclosure.

Similarly, a thickness of the body portion 100, a thickness of the first bending portion 101, a thickness of the second bending portion 102, a thickness of the first connecting portion 111, and a thickness of the second bending portion 102 may be set by a person skilled in the art according to actual requirements.

In some embodiments, referring to FIG. 1, the first bending portion 101 and the first side 11 have a first distance L1 in the third direction, the first bending portion 101 and the second bending portion 102 have a second distance L2 in the third direction, and the first distance L1 and the second distance L2 have a ratio in a range of 1% to 50%, which may be, for example, 1%, 10%, 23%, 38%, 43%, 50%, etc. With the ratio of the first distance L1 to the second distance L2 being in the above range, the first bending portion 101 has a larger space for deformation, which can alleviate the installation tolerance between the two cell modules so as to improve the yield of the cell module, and the distance between the first bending portion 101 and the body portion causes a gap between the body portion and the cell module, thereby improving the heat dissipation of the connecting member.

In some embodiments, referring to FIG. 1 or FIG. 6, the second bending portion 102 and the second side 12 has a fifth distance L5, and a ratio of the fifth distance L5 to the second distance L2 is in a range of 1% to 50%, which may be, for example, 1%, 10%, 23%, 38%, 43%, 50%, etc. With the ratio of the fifth distance L5 to the second distance L2 being in the above range, the second bending portion 102 has a larger space for deformation, which can alleviate the installation tolerance between the two cell modules so as to improve the yield of the cell module, and the distance between the second bending portion 102 and the body portion 100 causes a gap between the body portion 100 and the cell module, thereby improving the heat dissipation of the connecting member.

In some embodiments, the first distance L1 in a range of 0 mm to 2.5 mm, which may be, for example, 0 mm, 0.8 mm, 1.3 mm, 1.6 mm, 2.0 mm, 2.5 mm, etc. With the first distance L1 being in the above range, there is a gap between the first bending portion 101 and the body portion 100 to avoid interference and improve the heat dissipation function of the connecting member. The first distance L1 being in the above range can also reduce the distance between the two cell groups, so that more cells are integrated in a limited space, and the energy storage battery pack has a larger battery capacity.

In some embodiments, referring to FIG. 4, the first connecting portion 111 (referring to FIG. 1) and the body portion 100 has a third distance L3, the second connecting portion 112 (referring to FIG. 1) and the body portion 100 has a fourth distance L4, and at least one of the third distance L3 and the fourth distance L4 is in a range of 2 mm to 100 mm. The lengths of the third distance L3 and the fourth distance L4 are used to ensure that there is no interference between the body portion 100 and a low-voltage connector on an endplate and the length of the connecting member is moderate. The length of the connecting member being moderate means that the length of the connecting member can meet the current carrying requirements of the connecting member and is not too long to waste materials.

In some embodiments, referring to FIG. 2 or FIG. 5, the body portion 100 has a first buffer structure 103, and the first buffer structure 103 is disposed between the first bending portion 101 and the second bending portion 102. The first buffer structure 103 is configured to reduce a jitter influence between two adjacent cell modules, and the first buffer structure 103 may avoid the breaking of welding spots is disconnected between the connecting member and the cell module.

In some embodiments, the first direction and the third direction constitute a reference surface, and an orthographic projection of the first buffer structure 103 on the reference surface has a wave shape or a folding line shape. The design of the first buffer structure 103 can effectively utilize the material area, and the first buffer structure 103 does not cause the body portion 100 to be disconnected. The first buffer structure 103 is a bending design and a deformation process of the body portion 100, and the connecting member is a integrally formed structure without a fracture opening, so that the current-carrying capacity of the connecting member does not change, and an internal resistance of the connecting member is also small. The strength of the connecting member is relatively large, which improves the stability and reliability of the cell module.

In some embodiments, the connecting member further includes a second buffer structure, and the second buffer structure is disposed on at least one of the first bending portion 101 and the second bending portion 102. The second buffer structure may further improve stability and reliability of the connecting member.

In some embodiments, an orthographic projection of the second buffer structure on the reference surface has a wave shape or a folding line shape.

In some embodiments, a maximum length of the first buffer structure 103 in the third direction is less than 2 mm, so that interference between the first buffer structure 103 and another component may be avoided.

With continued reference to FIG. 1, each of the first connecting portion 111 and the second connecting portion 112 has a mounting hole for riveting with an output member. Taking the mounting hole on the first connecting portion 111 as an example, an edge of the mounting hole and an edge of the first connecting portion 111 has a first edge distance S1 in the first direction, and the first edge distance S1 is greater than or equal to 20 mm. The edge of the mounting hole and the edge of the first connecting portion 111 has a second edge distance S2 in the third direction, and the second edge distance S2 is greater than or equal to 20 mm. With the first edge distance S1 and the second edge distance S2 being in the above range, the probability of breakage of the edge during subsequent mounting of the screw is reduced.

In some embodiments, the width and thickness of the connecting member (the cross-sectional area of the connecting member) may be set according to an over-current requirement of the entire cell module, which is not limited in the present disclosure.

The connecting member includes the body portion 100, the first bending portion 101, the second bending portion 102, the first connecting portion 111, and the second connecting portion 112. The body portion 100 extends from a first end of the body portion 100 to a second end of the body portion 100 in a first direction and from a first edge of the body portion 100 to a second edge of the body portion 100 in a second direction. The first bending portion 101 and the second bending portion 102 are disposed at the first end and the second end of the body portion 100, the first bending portion 101 is connected to the first end of the body portion 100 and is bent from the first end of the body portion 100 towards the second direction on the first side 11 of the body portion 100, and the second bending portion 102 is connected to the second end of the body portion 100 and is bent from the second end of the body portion 100 towards the second direction on the second side 12 of the body portion 100. The first connecting portion 111 is bent from the end of the first bending portion 101 away from the body portion 100 towards the third direction; and the third direction is a direction from the second side 12 to the first side 11. The second connecting portion 112 is bent from the end of the second bending portion 102 towards the fourth direction away from the body portion 100, and the fourth direction is a direction from the first side to the second side. This makes a length of the connecting member no longer limited to a gap between cell modules, i.e., a length direction of the connecting member is changed from an arrangement direction of two cell modules to a vertical direction and a horizontal direction, so that a width direction of the body portion can be a vertical direction of the cell module. In this way, at least the length in the length direction of the connecting member can be increased to a length of one cell module and a height of one cell module. Compared to the conventional solution that the connecting member electrically connects adjacent cell modules in the horizontal direction, the length of the connecting member in the present disclosure can be increased so as to ensure that the connecting member has a sufficient length for ensuring current-carrying between total output ends of different cell modules, and thus avoiding thermal problems and loss of current-carrying of the cell module caused by excessive current-carrying.

In addition, the first bending portion 101 is bent from the first end towards the second direction on the first side 11, and the second bending portion 102 is bent from the second end towards the second direction on the second side 12. The gap between the two cell modules does not need to occupy a large space because of current-carrying and installation problems of the connecting member, so that the gap between the two cell modules can be shortened, and a part of the space can be reduced in the length direction of the cell module to be given to other components, so as to improve the integration of cell modules. A bending surface of the first bending portion 101 and a bending surface of the second bending portion 102 are opposite to each other, so that either of the first bending portion and the second bending portion can counteract fluctuations from the other, without greatly affecting the deformation of the first bending portion or the second bending portion itself.

Accordingly, another aspect of the embodiments of the present disclosure further provides a cell module, including the connecting member provided in the foregoing embodiments, and the same or corresponding technical features in the foregoing embodiments are not described in detail herein again.

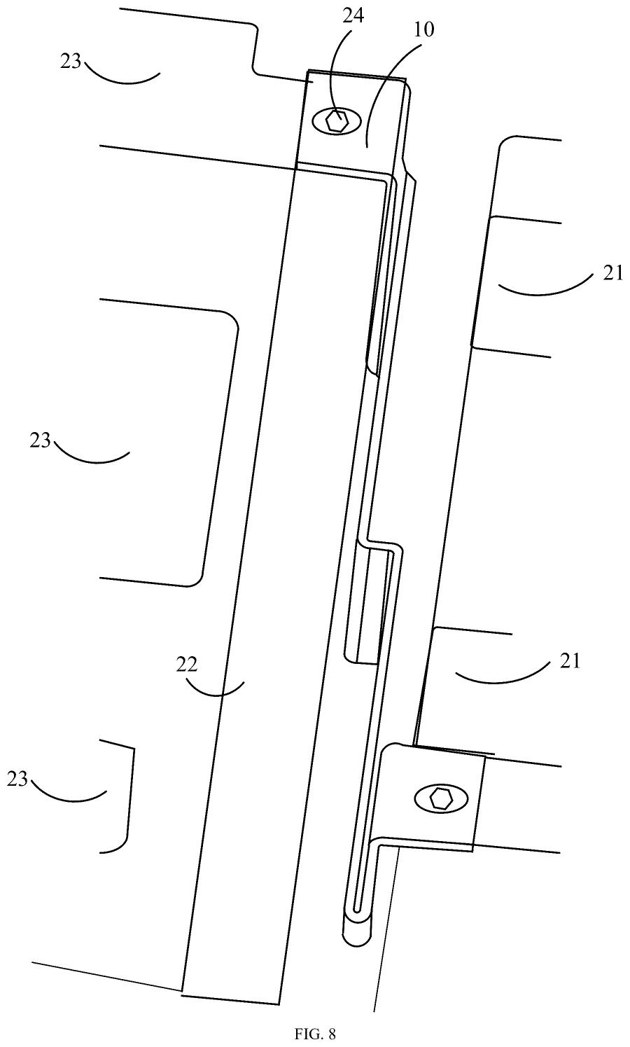

FIG. 7 is a partial schematic structural diagram of a cell module according to an embodiment of the present disclosure. FIG. 8 is another partial schematic structural diagram of a cell module according to an embodiment of the present disclosure.

Referring to FIG. 7, the cell module includes at least two cell groups and the connecting member as described in any one of the above embodiments. Each of at least two cell groups includes an output end, and the output end includes an output member 23. Both ends of the connecting member 10 are in electrical contact with output members 23 of two cell groups, respectively.

In some embodiments, the cell group refers to a plurality of cells sequentially arranged in a fifth direction. The plurality of cells are connected in series by means of bus connectors. Each cell includes a positive electrode, a negative electrode, and an explosion-proof port, and both ends of a bus connector are electrically connected to electrodes of two cells respectively, for example, the bus connector is electrically connected to a positive electrode of one of the cells and a negative electrode of the other of the cells. The fifth direction may be the third direction in the above embodiments.

In some embodiments, the bus connector may be aluminum bar, the resistance and price of the aluminum bar are low, weldability between a material of the aluminum bar and a material of the positive electrode and the negative electrode is relatively high, and the aluminum bar can reduce the contact resistance between the bus connector and the cells.

In some embodiments, each of both ends of the cell group has a total output end, the total output end refers to one of electrodes of an outermost cell, the output member is connected to the total output end, and the output member may be the aluminum bar.

In some embodiments, the output member is connected to the connecting member through a stud, ultrasonic welding, and hot-pressing welding. Referring to FIG. 7, the output member 23 and the connecting member 10 are fixed by the stud 24 as an example in the present disclosure.

In some embodiments, the output member 23 and the connecting member 10 are integrally formed, so that there is no need to separately assemble the connecting member on the output member in the assembly process of the cell module, thereby saving the assembly time of the cell module and improving the assembly efficiency. Meanwhile, since the output member does not need to be provided with a stud, the height of the cell module can be reduced, that is, the occupied space is reduced. When the cell module is assembled, there is no need to use a tool to assemble the stud, so that the space required for assembly can be further saved to meet the space limitation when the cell module is side-mounted, and the installation cost can also be reduced. When the cell module is side-mounted in a box body of the battery pack, the reserved space between the two cell modules opposite to each other can be reduced, so that the assembly of the two cell modules is more compact, and the volume of the battery pack is reduced.

Meanwhile, the output member and the connecting member are integrally formed, so that a surface of the connecting member and a surface of the output member at the connecting position are in close contact, and the output member at the connecting position is tightly combined with molecules of the connecting member, so that a redox reaction can be effectively avoided, that is, corrosion at the connecting position is avoided. Therefore, the connection position between the output member and the connecting member can be effectively protected, and the service life of the cell module is prolonged.

In some embodiments, the cell module further includes an endplate 22 and an output base 21. The end plate 22 is disposed at both ends of the cell group, and the first connecting portion 111 (referring to FIG. 1) of the connecting member 10 is disposed on the end plate 22. The output base 21 is disposed on the end plate 22. A top surface of the body portion 100 (referring to FIG. 1) of the connecting member 10 is not higher than a bottom surface of the output base 21, so that interference between the connecting member 10 and the output base 21 may be avoided.

In some embodiments, the cell module further includes connecting structures disposed between the first connecting portion of the connecting member and the output member and between the second connecting portion of the connecting member and the output member, respectively. The connecting structure has an upper surface and a lower surface, the upper surface of the connecting structure is welded to the connecting member, and the lower surface of the connecting member is welded to the output member. Due to the fact that the welding performance between aluminum and copper is generally and the welding performance between the material of the connecting member and the material of the first connecting portion or the material of the second connecting portion is good, an additional connecting member is provided as a welding spacer between the output member and the connecting member, the welding performance between the connecting member and the output member is improved, so that the contact performance between the output member and the connecting member is improved.

In some embodiments, the connection structure surrounds one of the first connecting portion and the second connecting portion.

In some embodiments, the cell group includes at least one column of cells arranged in the third direction. In some embodiments, referring to FIG. 8, the cell group includes two columns of cells arranged in the third direction. In this way, the connecting member may be designed based on different cells, and this solution has high practicability.

Accordingly, another aspect of the embodiments of the present disclosure further provides an energy storage battery pack, including the cell module provided in the foregoing embodiments, and the same or corresponding technical features in the foregoing embodiments are not described in detail herein again.

In some embodiments, the energy storage battery pack includes a plurality of cell modules according to any one of the above embodiments.

In some embodiments, the energy storage battery pack may be a pack in an energy storage cabinet, and the plurality of cell modules are regularly arranged to form the energy storage battery pack. A specific number of the cell modules may be set as required, which is not specifically limited herein. For example, the number of cell modules may be set to one, two, four, five, six, or the like.

In some embodiments, the energy storage battery pack further includes a battery management system (BMS), and the BMS may be configured to control and detect the operation of each cell module.

Although some embodiments are disclosed in the present disclosure, they are not intended to limit the claims, any person skilled in the art can make several possible variations and modifications without departing from the concept of the present disclosure, and therefore, the protection scope of the present disclosure shall be subject to the scope defined by the claims of the present disclosure.

A person of ordinary skill in the art may understand that the foregoing implementations are specific embodiments for implementing the present disclosure, and in practical applications, various changes may be made in form and detail without departing from the scope of the present disclosure. Any person skilled in the art may make various changes and modifications without departing from the scope of the present disclosure, and therefore, the protection scope of the present disclosure shall be subject to the scope defined by the claims.

What is claimed is:

1. A connecting member configured to electrically connect output ends of two cell groups, comprising:
a body portion having a first side and a second side opposite to each other, wherein the body portion extends from a first end of the body portion to a second end of the body portion in a first direction and from a first edge of the body portion to a second edge of the body portion in a second direction;
a first bending portion and a second bending portion, wherein the first bending portion and the second bending portion are respectively disposed at the first end and the second end of the body portion, the first bending portion is connected to the first end of the body portion and is bent from the first end of the body portion towards the second direction on the first side of the body portion, and the second bending portion is connected to the second end of the body portion and is bent from the second end of the body portion towards the second direction on the second side of the body portion;
a first connecting portion, wherein the first connecting portion is connected to an end of the first bending portion away from the body portion and is bent from the end of the first bending portion towards a third direction, and the third direction is a direction from the second side to the first side; and
a second connecting portion, wherein the second connecting portion is connected to an end of the second bending portion away from the body portion and is bent from the end of the second bending portion towards a fourth direction, and the fourth direction is a direction from the first side to the second side.

2. The connecting member according to claim 1, wherein the first bending portion and the first side has a first included angle, the second bending portion and the second side has a second included angle, and at least one of the first included angle and the second included angle is in a range of 0° to 30°.

3. The connecting member according to claim 1, wherein the first bending portion has a first bending angle, the second bending portion has a second bending angle, and at least one of the first bending angle and the second bending angle is greater than 0° and less than 90°.

4. The connecting member according to claim 1, wherein the first bending portion and the first side have a first distance L1 in the third direction, the first bending portion and the second bending portion have a second distance L2 in the third direction, and a ratio of the first distance L1 to the second distance L2 is in a range of 1% to 50%.

5. The connecting member according to claim 4, wherein the first distance L1 is in a range of 0 mm to 2.5 mm.

6. The connecting member according to claim 1, wherein the body portion includes a first buffer structure, and the first buffer structure is disposed between the first bending portion and the second bending portion.

7. The connecting member according to claim 6, wherein the first direction and the third direction form a reference surface, and an orthographic projection of the first buffer structure on the reference surface has a wave shape or a folding line shape.

8. The connecting member according to claim 1, further comprising a second buffer structure, wherein the second buffer structure is disposed on at least one of the first bending portion and the second bending portion.

9. The connecting member according to claim 1, wherein the first connecting portion and the body portion has a third distance, the second connecting portion and the body portion has a fourth distance, and at least one of the third distance and the fourth distance is in a range of 2 mm to 100 mm.

10. A cell module, comprising:
at least two cell groups, wherein each of the at least two cell groups includes an output end, and the output end includes an output connector; and
a connecting member, wherein both ends of the connecting member are in electrical contact with output connectors of two of the at least two cell groups, respectively;
wherein the connecting member includes:
a body portion having a first side and a second side opposite to each other, wherein the body portion extends from a first end of the body portion to a second end of the body portion in a first direction and from a first edge of the body portion to a second edge of the body portion in a second direction;
a first bending portion and a second bending portion, wherein the first bending portion and the second bending portion are respectively disposed at the first end and the second end of the body portion, the first bending portion is connected to the first end of the body portion and is bent from the first end of the body portion towards the second direction on the first side of the body portion, and the second bending portion is connected to the second end of the body portion and is bent from the second end of the body portion towards the second direction on the second side of the body portion;
a first connecting portion, wherein the first connecting portion is connected to an end of the first bending portion away from the body portion and is bent from the end of the first bending portion towards a third direction, and the third direction is a direction from the second side to the first side; and
a second connecting portion, wherein the second connecting portion is connected to an end of the second bending portion away from the body portion and is bent from the end of the second bending portion towards a fourth direction, and the fourth direction is a direction from the first side to the second side.

11. The cell module according to claim 10, further comprising:
an endplate, wherein the endplate is disposed at both ends of the at least two cell groups, and the first connecting portion of the connecting portion is disposed on the endplate; and
an output base disposed on the endplate;
wherein the body portion of the connecting portion has a top surface that is not higher than a bottom surface of the output base.

12. The cell module according to claim 10, further comprising: connecting structures, wherein the connecting structures are disposed between the first connecting portion of the connecting member and the output connector and between the second connecting portion of the connecting member and the output connector, respectively.

13. The cell module according to claim 12, wherein the connecting structure surrounds one of the first connecting portion and the second connecting portion.

14. The cell module according to claim 10, wherein each of the at least two cell groups includes at least one column of cells arranged in the third direction.

15. The cell module according to claim 14, wherein each of the at least two cell groups includes two columns of cells arranged in the third direction.

16. An energy storage battery pack, comprising a plurality of cell modules, wherein each of the plurality of cell modules includes:
at least two cell groups, wherein each of the at least two cell groups includes an output end, and the output end includes an output connector; and
a connecting member, wherein both ends of the connecting member are in electrical contact with output connectors of two of the at least two cell groups, respectively;
wherein the connecting member includes:
a body portion having a first side and a second side opposite to each other, wherein the body portion extends from a first end of the body portion to a second end of the body portion in a first direction and from a first edge of the body portion to a second edge of the body portion in a second direction;
a first bending portion and a second bending portion, wherein the first bending portion and the second bending portion are respectively disposed at the first end and the second end of the body portion, the first bending portion is connected to the first end of the body portion and is bent from the first end of the body portion towards the second direction on the first side of the body portion, and the second bending portion is connected to the second end of the body portion and is bent from the second end of the body portion towards the second direction on the second side of the body portion;
a first connecting portion, wherein the first connecting portion is connected to an end of the first bending portion away from the body portion and is bent from the end of the first bending portion towards a third direction, and the third direction is a direction from the second side to the first side; and
a second connecting portion, wherein the second connecting portion is connected to an end of the second bending portion away from the body portion and is bent from the end of the second bending portion towards a fourth direction, and the fourth direction is a direction from the first side to the second side.

17. The energy storage battery pack according to claim 16, wherein each of the plurality of cell modules further includes:
an endplate, wherein the endplate is disposed at both ends of the at least two cell groups, and the first connecting portion of the connecting portion is disposed on the endplate; and
an output base disposed on the endplate;
wherein the body portion of the connecting portion has a top surface that is not higher than a bottom surface of the output base.

18. The energy storage battery pack according to claim 16, wherein each of the plurality of cell modules further includes connecting structures, wherein the connecting structures are disposed between the first connecting portion of the connecting member and the output connector and between the second connecting portion of the connecting member and the output connector, respectively.

19. The energy storage battery pack according to claim 18, wherein the connecting structure surrounds one of the first connecting portion and the second connecting portion.

20. The energy storage battery pack according to claim 16, wherein each of the at least two cell groups includes at least one column of cells arranged in the third direction.
